(19) United States
(12) Patent Application Publication
(10) Pub. No.: US 2012/0278106 A1
(43) Pub. Date: Nov. 1, 2012

(54) Personal Information Gathering, Storing, and Transfer System and Method of Use

(76) Inventor: John Frank Stagl, Osprey, FL (US)

(21) Appl. No.: 13/540,755

(22) Filed: Jul. 3, 2012

Related U.S. Application Data
(63) Continuation-in-part of application No. 12/622,531, filed on Nov. 20, 2009.
(60) Provisional application No. 61/116,418, filed on Nov. 20, 2008.

(51) Int. Cl. G06Q 50/24

(52) U.S. Cl. 705/3

(57) ABSTRACT

A personal information gathering, storing, and transfer system having a display, an input device, and a processor in data communication with the display and input device for receiving data from the input device and actuating the display. An internal memory is in data communication with the processor and the input device for storing data received from the input device. The display and input device may be a touch screen. The system includes a USB port in data communication with the processor and internal memory. The system includes a portable memory device configured for data connection to the USB port for receiving data from the internal memory. The processor includes programming for automatically deleting data from the internal memory when transferred to the portable memory.

### CROSS REFERENCE TO RELATED APPLICATIONS

This application claims the benefit of U.S. application Ser. No. 12,622,531 filed Nov. 20, 2009 entitled Personal Information Gathering, Storing, and Transfer System, which claims the benefit of U.S. Application No. 61/116,418 filed Nov. 20, 2008 entitled PIC, an Acronym for Personal Information Capture and Store System.

### BACKGROUND OF THE INVENTION

This invention relates generally to information systems and, more particularly, to a system for gathering and storing personal medical information and then transferring it to a portable storage device for transfer and use by other selected parties.

When a patient visits a health professional, data such as full name, address, insurance, occupation, habits, social history, current health problem (if one exists), past medical history, medication, surgeries, allergies, etc. is collected. Presently, the data is generally collected using a paper form that the client/individual will fill out using a pen. This is not only time consuming but grossly redundant, whereby the client/individual is required to fill out the same or similar form for each and every medical professional visited.

Some medical establishments have added the convenience of touch screens to improve the delivery of patient data. This information may be added to the Electronic Medical Records (EMR) system at the current office only. Nevertheless, upon visiting another medical professional for the first time, the patient will again be required to fill out paperwork prior to the visit.

The main problem with this present system is that the medical establishment requires information yet often fails to share the same information with the patient who rendered it in the first place. A patient can indeed obtain copies of records from the medical professional; however copies of records are generally unacceptable to other professionals for intake purposes. Often times the prior office logo and letterhead may be attached and the information may not be as complete as desired.

Therefore, it would be desirable to have a system by which the individual can create a portable electronic health record, establish, update and maintain control of their own medical records, and disseminate such records easily and quickly to the medical professional of their choice. Such a system would allow an individual the ability to electronically update their information privately, conveniently and inexpensively.

### SUMMARY OF THE INVENTION

The present invention is a personal information gathering, storing, and transfer system in which an individual can create a portable electronic health record, establish and maintain control of their own medical record, and have the ability to disseminate such records easily and quickly to the medical professional of their choice. The information system includes a display, an input device, and a processor in data communication with the display and input device for receiving data from the input device and actuating the display accordingly. An internal memory is in data communication with the processor and the input device for storing data received through the input device. The display and input device may be a touch screen. The system includes a USB port in data communication with the processor and internal memory. The system includes a portable memory device configured for data connection to the USB port for receiving data from the internal memory. The processor includes programming for automatically deleting data from the internal memory when transferred to the portable memory as well as other security features.

In another aspect of the invention, the programming instructions are stored first in the memory of a portable memory device. The programming instructions are configured to self-install on a computer when the portable memory device is connected to the USB port of the computer. The programming instructions include a Continuing Care Record that is editable using a computer input device when the portable memory device is connected to a computer. The programming instructions are configured to enable a user to set an access code without which the Continuing Care Record is inaccessible. Certified electronic medical records are utilized to enable patients to transfer personal medical data to and between medical providers as is now mandated by U.S. government regulations and mandates.

Therefore, a general object of this invention is to provide a personal information system for gathering, storing, and transferring personal medical information to a portable memory device such that the information may be provided to selected medical professionals without repeated and redundant data entry.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a personal information gathering, storing, and transfer system according to a preferred embodiment of the present invention;

FIGS. 2a to 2c are screen shots of the data acquisition module of the present invention;

FIG. 3 is a block diagram of the electronic components of the present invention;

FIG. 4 is an isolated view on an enlarged scale of a portable electronic memory device taken from FIG. 1; and

FIG. 5 is a flowchart illustrating a method for using a portable memory device to gather, store, and transfer personal medical information.

### DESCRIPTION OF THE PREFERRED EMBODIMENT

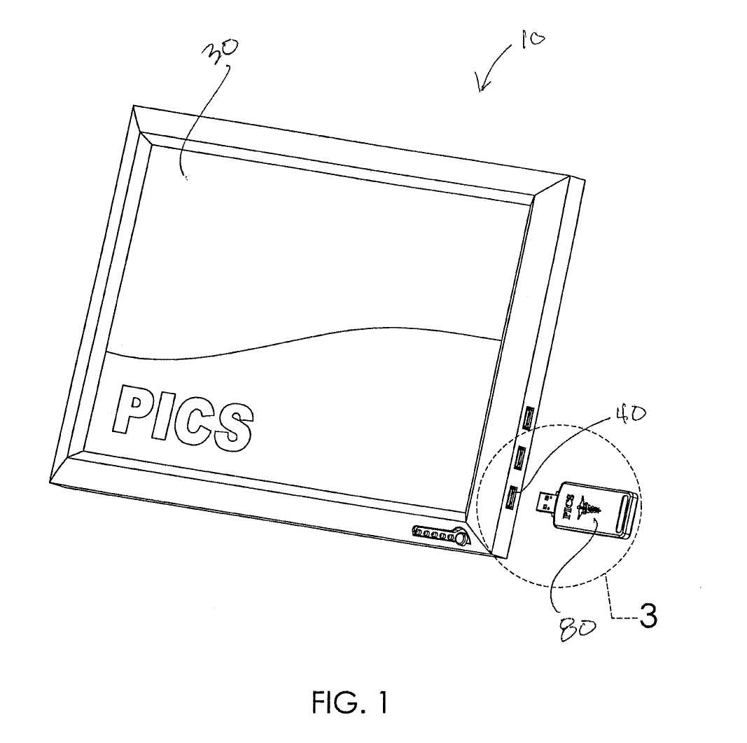

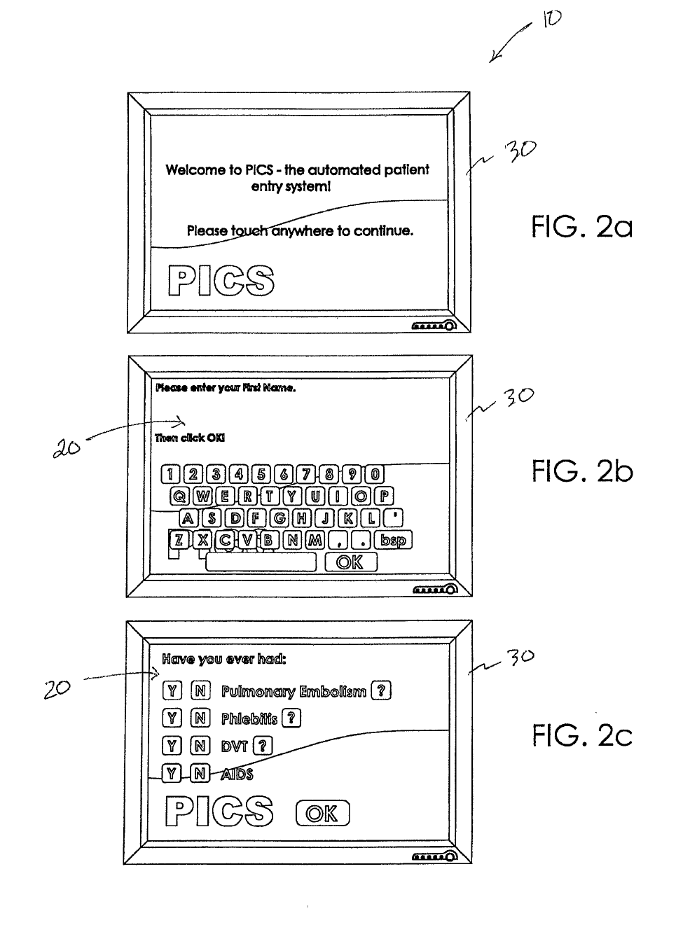

A personal information gathering, storing, and transfer system according to a preferred embodiment of the present invention will now be described with reference to FIGS. 1 to 4 of the accompanying drawings.

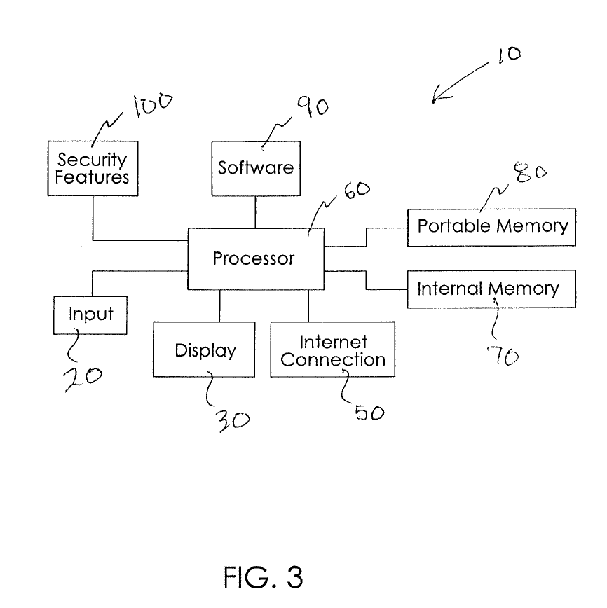

The personal information gathering, storing, and transfer system 10 (also referred to herein merely as a “personal information system”) includes an input device 20 and a display 30 (FIG. 1). Preferably, the input device 20 and the display 30 may be a touch screen. The personal information system 10 also includes a processor 60 in data communication with the input device 20 and display 30 such that data may be received from the input device 20, communicated to the processor 60, and the display 30 actuated accordingly. The electronic components of the present invention are shown in the block diagram of FIG. 3 and it is understood that the display 30 may provide a housing for many of the electronic components of the information system 10.

The information system is used exclusively to capture personal health related information such as individual full name, address, insurance information, occupation, habits, social history, their current health problem (if one exists), past medical history, medication, surgeries, allergies, etc. Although a touch screen device is preferred, any means for collecting data that can be stored electronically and made accessible by a portable memory device may be used.

The information system 10 according to the present invention further includes an internal memory 70 in connection with the input device 20 and processor 60. Data received by the input device 20 may be stored in the internal memory 70. Instructions, referred to in FIG. 3 as software 90, are stored in the internal memory 70 in data communication with the processor 60 that control entry of data through the input device 20, actuation of the display 30 accordingly, storage of data in the internal memory 70 and other operations of the processor 60 as will be described later.

Data collected through the input device 20 may be assembled under processor 60 control into a format that can be shared with others via a standard computer. More particularly, data may be assembled in a Portable Document Format (“PDF”) that may be displayed across many computer platforms, such as may be used by various medical professionals to whom it may be later submitted. A database is stored in the internal memory 70 having a plurality of program instructions, predetermined questions used in gathering personal and health information and the like. In an administrative mode, an administrator may customize which predetermined questions will be used and even to set up a help file that may later be accessed by a user when using the information system. The database may include data in various languages. Various security codes and such like may also be stored in the internal memory as will be described further later.

The display 30 defines a USB port 40 or other connection for auxiliary devices. It is understood, of course, that the USB port 40 may be provided on another peripheral device other than the display 30. The USB port 40 is in data communication with the processor 60 and internal memory 70 such that data stored in the internal memory 70 may be transferred to the USB port 40.

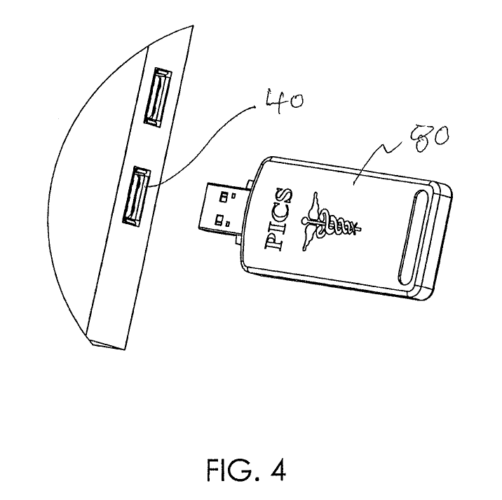

The information system 10 may also include a portable memory device 80 configured to be removably connected to the USB port 40 and capable of receiving and storing data transferred from the internal memory 70 through the USB port 40. It is understood that the portable memory device may broadly be construed as a flash drive, memory stick, floppy disk, removable hard drive, or other suitable memory device not permanently attached or mounted in the computer. The portable memory device 80 is preferably a flash drive as shown in FIG. 4; this is preferred in that such a device may be placed on a key chain, placed in a pen, on a card similar in size to a credit card or placed on a lariat. In addition, the information system 10 may include an internet connection 50 (FIG. 3) such that data stored in the internal memory 70 may be transferred to selected remote computers, such as the user's personal computer or the computer of a selected medical professional.

In another aspect of the invention, the portable memory device 80 may include data storage media such as a memory component having data structures that are specifically configured to receive and store personal health data in a format consistent with that which is used in Electronic Medical Records (EMR). In other words, the portable memory device 80 may include specific memory locations to store one or more “Continuing Care Records (“CCR).” The portable memory device includes programming instructions stored in the memory component, the programming instructions being configured to receive, prepare, and format the information received through the input device 20 of a computer to be received into respective data structures of the portable memory device 80.

Preferably, the software 90 and portable memory device 80 are configured to receive and store data in the Continuing Care Record using the Health Level 7 messaging system as this messaging system is used prominently by health professionals. Accordingly, data stored on the portable memory device 80 in a HL 7 format may be readily uploaded to the Electronic Medical Records (EMR) of other health professionals when desired by the user.

The programming instructions stored on the portable memory device 80 are configured to self-install on the internal memory of a computer when the portable memory device 80 is operatively connected thereto, such as by connection to a USB port. The Continuing Care Record(s) stored on the portable memory device 80 is selectively modifiable (i.e. can be edited) when the programming instructions are executed by the processor of the computer. In operation, a patient's CCR may be uploaded from the portable memory device to the computer when attached to the computer's USB port, enabling a patient may report personal health history data on a Continuing Care Record using the input (i.e. keyboard or mouse).

Further, the programming instructions are configured to automatically delete data from the internal memory 70 of the computer when it is transferred and stored onto the portable memory device 80. In other words, the programming instructions enable a CCR to be uploaded to a computer and modified according to new health information and then returned to the memory device 80. This programming is a security feature in that a user's personal data is not left on the local computer once it has been transferred to the portable memory device 80. This is important in that the personal information system 10 or other remote computer may be positioned in a public area, such as a doctor's office waiting room, a public library, a shopping mall kiosk, or other public location where it may be accessed by unrelated parties.

Further, the programming instructions may also generate an access code when data is transferred to the portable memory device 80 or from the portable memory device 80 to a computer such that the transferred data cannot be accessed without entering the code. Alternately, other data protection methods may be used such as encryption with a private key. In other words, access to the portable memory device 80 and its contents may be password protected. Further, the display 30 may include a privacy screen (not shown) that prevents persons adjacent to the display 30 from viewing the screen. In FIG. 3, these security features are indicated together by reference numeral 100.

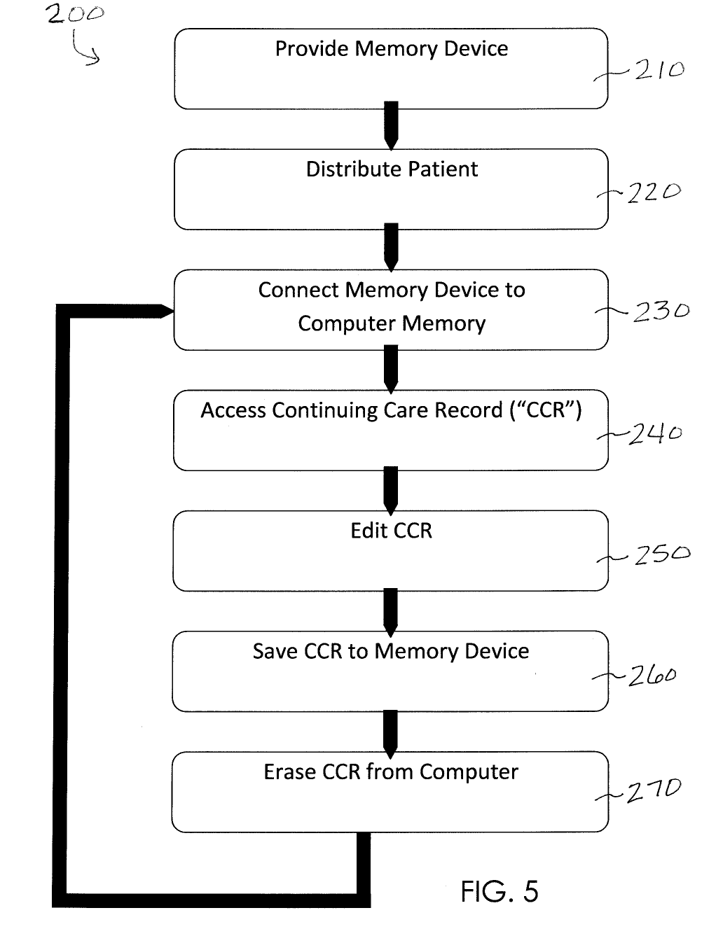

In operation, a method 200 for gathering, storing, and transferring medical information is provided by the structures and programming described above, the method illustrated in FIG. 5. More particularly, a portable memory device 80 or a plurality of portable memory devices is/are provided 210 and distributed 220 to patient(s). Each portable memory device 80 includes a memory component configured to store the programming instructions and one or more Continuing Care Records. The patient may connect his respective portable memory device 80, i.e. the specially configured flash drive or memory stick, into the USB port of a computer, as indicated a step 230. It is understood that reference to a computer may include an information system as described above or another computer into whose internal memory the program instructions are automatically loaded when the memory device 80 is connected to the USB port. Under program control, then, a user—such as the patient or healthcare provider—may access a Continuing Car Record, indicated at step 240, and then input or edit personal health information into a respective CCR, as indicated at step 250. It is understood that the user or healthcare provider may be required to enter a password in order to gain access to the CCR. When finished, the program instructions may cause the CCR to be stored again to the portable memory device, as indicated at step 260, and, consequently, the data is erased from the computer's memory at step 270. Erasure of the data may be prompted by removal of the memory device 80 from the respective USB port. It is understood that the portable memory device 80 may be subsequently connected to another computer via its USB port and the CCR accessed and/or updated, such as with healthcare information from another healthcare provider. In this case, control is returned to step 230.

It is understood that while certain forms of this invention have been illustrated and described, it is not limited thereto except insofar as such limitations are included in the following claims and allowable functional equivalents thereof.

What is claimed is:

1. A method for gathering, storing, and transferring medical information of a patient, comprising the steps:
providing a portable memory device having a memory and predetermined program instructions stored in said memory, said portable memory device including a Continuing Care Record stored in said memory and configured to selectively receive the patient's medical data;
distributing said personal memory device to the patient;
wherein:
said program instructions are configured to install on an internal memory of a computer having an input device when said portable memory device is connected to the computer's USB port, said Continuing Care Record being capable of modification through use of the computer's input device when said program instructions are installed on the computer;
said program instructions are configured to enable the patient to set an access code without which predetermined received patient medical data in said Continuing Care Record is inaccessible by the computer; and
said program instructions are configured to erase said Continuing Care Record from the memory of the computer when said portable memory device is disconnected from the computer.

2. The method as in claim 1, wherein said Continuing Care Record is compatible with Electronic Medical Record software of a health professional computer.

3. The method as in claim 1, wherein said computer includes:
a display;
an input device;
a processor in data communication with said display and said input device;
an internal memory in data communication with said processor;
a USB port in data communication with said processor and said internal memory; and
wherein said internal memory is configured to receive said program instructions when said portable memory device is connected to said USB port.

4. The method as in claim 1, wherein said display is a touch screen.

5. The method as in claim 4, wherein said portable memory device is one of a flash drive and a memory stick.

6. The method as in claim 5, wherein said display includes a privacy screen attached to a front side of said display and is configured such that said display is not visible to persons adjacent said display.

7. The method as in claim 5, wherein said program instructions include:
a database of medical history questions configured to be displayed on said computer display when said portable memory device is connected to said computer USB port; and
means for enabling an administrator to select respective medical history questions for display.

8. The method as in claim 2, wherein said Continuing Care Record is compatible with a Health Level 7 Emergency Medical Record format.
